(19) United States
(12) Patent Application Publication
(10) Pub. No.: US 2012/0049654 A1
(43) Pub. Date: Mar. 1, 2012

(54) ELECTRONIC DEVICE AND POWERING OFF METHOD FOR THE ELECTRONIC DEVICE

(75) Inventors: SHIH-FANG WONG, Tu-Cheng (TW); XIN LU, Shenzhen City (CN); HUAN-HUAN ZHANG, Shenzhen City (CN); JUN-JIE LI, Shenzhen City (CN); BIAO-GENG ZHONG, Shenzhen City (CN); XUE-SHUN LIU, Shenzhen City (CN); DAN WANG, Shenzhen City (CN); BI-QING LUO, Shenzhen City (CN); FEI WANG, Shenzhen City (CN); LI-XIA PENG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 12/910,854

(22) Filed: Oct. 24, 2010

(30) Foreign Application Priority Data
Aug. 31, 2010 (CN) 201010268165.9

(51) Int. Cl. H02J 1/00

(52) U.S. Cl. 307/125

(57) ABSTRACT

An electronic device is provided. The electronic device is connected to an external power supply through an interface. The electronic device comprises a processing unit and an input unit. The input unit responds to a power off operation to generate a power off signal and sends the power off signal to the processing unit. The processing unit periodically checks whether the electronic device is disconnected from the external power supply after receiving the power off signal, and powers off the electronic device if the electronic device is disconnected from the external power supply.

### BACKGROUND

1. Technical Field

The present disclosure relates to an electronic device and a method for powering off the electronic device.

2. Description of Related Art

During factory testing of electronic devices, external power sources are used to implement certain tests. When testing devices that do not have an operating system (OS), after detecting connection of the device being tested to an external power source, a power management unit (PMU) will automatically power up the electronic device and supply power to all the components of the electronic device. Therefore, if the test technician turns off the electronic device first before disconnecting the external power source, because of the connection of the external power, the electronic device will automatically turn back on and remain on even after the external power source is disconnected. This wastes times and may cause other problems if the technician forgets to disconnect the external power source first.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device in accordance with an exemplary embodiment.

FIG. 2 is a flowchart of a method for powering off the electronic device of

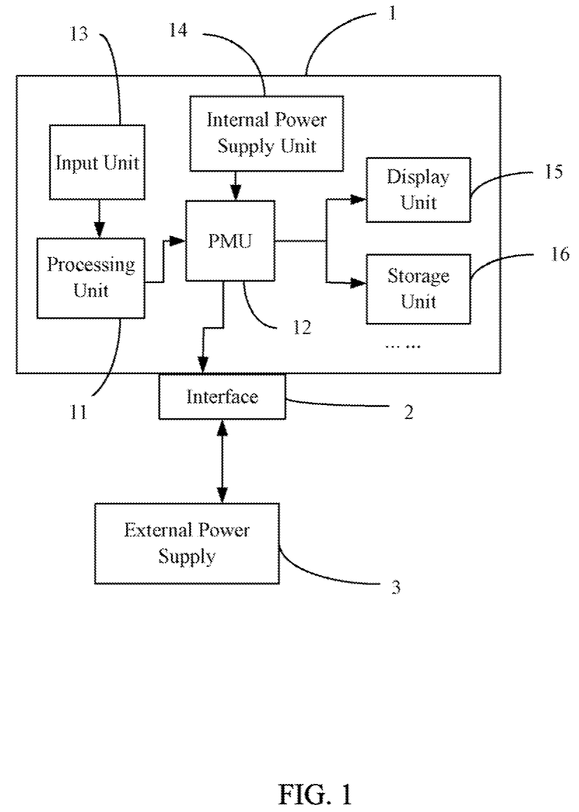

FIG. 1.

### DETAILED DESCRIPTION

Referring to FIG. 1, an electronic device 1 of the present disclosure is operable to be connected to an external power supply 3. Only when a connection between the electronic device 1 and the external power supply 3 is disconnected, can the electronic device 1 be turned off.

FIG. 1 is a block diagram of the electronic device 1 in accordance with an exemplary embodiment. The electronic device 1 is connected to the external power supply 3 through an interface 2. In the exemplary embodiment, the electronic device 1 can be a cell-phone or a media player. The interface 2 can be a Micro-USB interface or a common charge interface.

The electronic device 1 includes a processing unit 11, a power management unit (PMU) 12, an input unit 13, an internal power supply unit 14, and other components, such as a display unit 15 and a storage unit 16. The internal power supply unit 14 supplies power to the electronic device 1 through the PMU 12.

The input unit 13 generates a power off signal in response to a power off operation thereon and sends the power off signal to the processing unit 11. After receiving the power off signal, the processing unit 11 periodically checks whether the electronic device 1 has been disconnected from the external power supply 3. The processing unit 11 controls the PMU 12 to cut off the connection between the PMU 12 and the internal power supply unit 14 to power off the electronic device 1 if it is determined that the electronic device 1 has been disconnected from the external power supply 3.

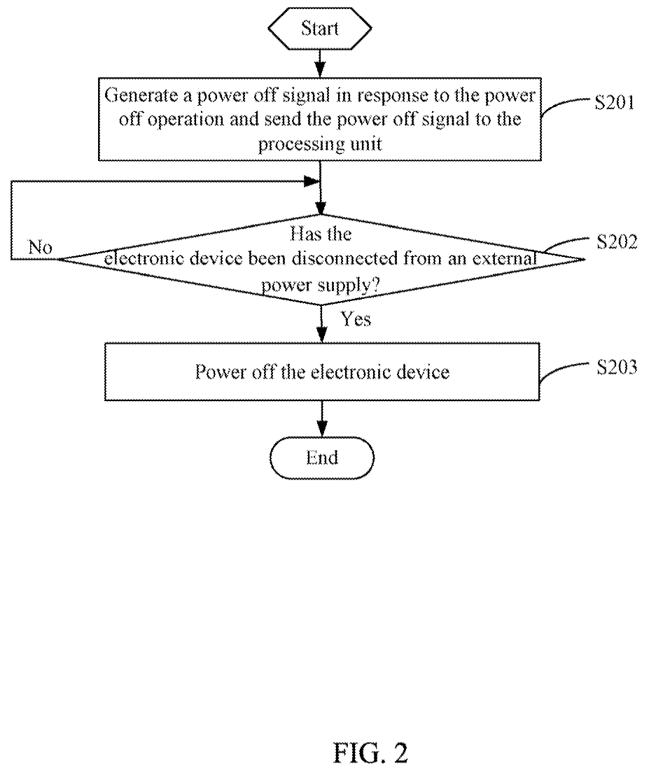

FIG. 2 is a flowchart of a method for powering off the electronic device 1 of FIG. 1. In step S201, the input unit 13 generates the power off signal in response to the power off operation thereon and sends the power off signal to the processing unit 11.

In step S202, the processing unit 11 receives the power off signal, and periodically checks whether the electronic device 1 has been disconnected from the external power supply 3. If the electronic device 1 has been disconnected from the external power supply 3, the procedure goes to step S203.

In Step 203 the processing unit 11 control the PMU 12 to disconnect from the internal power supply unit 14, thus powering off the electronic device 1. This way a technician is alerted to the fact they are trying to turn off power sources in the wrong order when the device fails to turn off if they have not first disconnect external power supply before directly turning off the device.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device connected to an external power supply through an interface, comprising:
a processing unit; and
an input unit for generating a power off signal in response to a power off operation and sending the power off signal to the processing unit;
the processing unit being operable to periodically detect whether the electronic device has been disconnected from the external power supply after receiving the power off signal, and powering off the electronic device if it is determined that the electronic device has been disconnected from the external power supply.

2. The electronic device as described in claim 1, further comprising a power management unit (PMU) and an internal power supply unit, wherein the PMU is connected to the internal power supply unit, the processing unit disconnects the internal power supply unit and the PMU to power off the electronic device.

3. The electronic device as described in claim 1, wherein the electronic device is a cell-phone or a media player.

4. The electronic device as described in claim 1, wherein the interface is a Micro-USB interface or a common charge interface.

5. A method for powering off an electronic device, the electronic device being connected to an external power supply through an interface, comprising:
generating a power off signal in response to a power off operation;
receiving the power off signal;
periodically detecting whether the electronic device has been disconnected from the external power supply after receiving the power off signal until that the electronic device has been disconnected from the external power supply; and
powering off the electronic device if it is determined that the electronic device has been disconnected from the external power supply.

6. The method as described in claim 5, wherein the electronic device further comprises a power management unit (PMU) and an internal power supply unit, the PMU is connected to the internal power supply unit, a way of powering off the electronic device is to disconnect the internal power supply unit and the PMU.

7. The method as described in claim 5, wherein the electronic device is a cell-phone or a media player.

8. The method as described in claim 5, wherein the interface is a Micro-USB interface or a common charge interface.
